(19) United States
(12) Patent Application Publication
(10) Pub. No.: US 2026/0105139 A1
(43) Pub. Date: Apr. 16, 2026

(54) Method and Apparatus for Plug and Charge Ecosystems with Multiple Service Providers

(71) Applicant: Irdeto B.V., Hoofddorp (NL)

(72) Inventors: Thomas Kelvin Clarke, Bournemouth (GB); Ian Gordon Auty, Woking (GB); Kyle James Ammann, Trophy Club, TX (US); Adam Wilkinson, Kanata (CA); James Patrick Simmermon, Kanata (CA); Evan Clough, Kanata (CA); Carla Trevino Navarro, Hoofddorp (NL)

(21) Appl. No.: 18/917,942

(22) Filed: Oct. 16, 2024

(51) Int. Cl. G06F 21/44

(52) U.S. Cl. CPC G06F 21/44

(57) ABSTRACT

A method and system for managing multiple Plug and Charge mobility service provider charging contracts outside a vehicle by installing a single contract certificate that can map to one or many mobility service provider charging contracts. After the authentication of the contract certificate, the mapping of the contract certificate to a charging contract is accomplished.

### BACKGROUND

The field of electric vehicle (EV) charging has seen significant advancements in recent years. One such advance is the use of “Plug and Charge” ecosystems. Secure Plug & Charge systems, such as described in the ISO 15118 industry standard enable an EV to automatically identify and authorize itself to a compatible charging station (operated by a “charge point operator” and a corresponding “mobility operator”) to receive energy for recharging its battery and to provide information for accounting purposes.

A vehicle can be identified via a certificate stored in the vehicle. Conventional processes leverage Provisioning Certificate Identifiers (PCIDs). A PCID includes a World Manufacturer Identifier (WMI), a unique identifier and a check digit. The WMI is 3 characters long and uniquely identifies the manufacturer (OEM) that made the vehicle. Further, a E-Mobility Account Identifier (EMAID), is used to allow the EV to automatically identify itself to a compatible charging station and receive energy for recharging its battery, without requiring any user intervention. EMAID is part of the ISO 15118 standard, which defines a vehicle to grid (V2G) communication interface for bi-directional charging/discharging of EVs as well as a Plug and Charge interface. The EMAID includes a CountryCode, a ProviderID, an EMA Instance, and a check digit. EMA is a software solution that enables remote management of devices using a web-based interface.

In the realm of electric vehicles, a contract certificate is a digital document that is securely installed in the vehicle and is used to authenticate the vehicle's charging contract with a mobility service provider. The contract certificate contains an EMAID which serves as a globally-unique identifier that is used to identify the vehicle owner's account with the mobility service provider.

When the vehicle is connected to a charge point, the charge point operator uses the EMAID in the contract certificate to verify the charging contract with the issuer of the contract before authorizing the charge. This verification process ensures that the vehicle owner has a valid contract with the mobility service provider and that the terms and conditions of the contract are met.

In conventional systems, each contract certificate is directly associated with a single charging contract. This means that if a vehicle owner has multiple charging contracts with different mobility service providers, they would have to install a separate contract certificate for each contract in their vehicle. However, many vehicles are designed to support the installation of just one contract certificate, which can pose a challenge for vehicle owners who have multiple charging contracts.

### SUMMARY

The process accomplished by plug and charge systems can be divided into five subprocesses:
1. vehicle production and preparation of contract-based billing (in which the OEM generates a Provisioning Certificate for each EV (corresponding to a vehicle ID) during production and installs a trust store containing all relevant Root Certificates from a RootCertificate Pool.
2. contract conclusion and vehicle assignment (in which a mobility operator concludes a charging contract for a specific customer's EV, using the vehicle's provisioning certificate from the provisioning certificate pool and the contract data is provided to the certificate provisioning service and/or the mobility operator).
3. periodic provisioning of contract data (signing contract data and storing in a contract pool, generating contract data by the mobility operator and storing the data in the contract certificate pool).
4. installation of contract data into the vehicle (providing signed contract data to charge point operator on request, and delivery of signed contract data to the OEM).
5. Vehicle provides the contract certificate to the charge point operator at the point of charging. The charge point operator requests that the mobility service provider that owns the contract authorizes the charge.

The disclosed implementations address inefficiencies associates with the sub process (4) noted above. The owner of a vehicle can have multiple contracts with many different mobility service providers. However, as noted above OEM's have developed vehicles that can only support the installation of a single contract certificate. Therefore, in order to accommodate multiple charging contracts a mechanism for swapping out contract certificates, depending on user preferences, must be utilized. Such a mechanism does not exist within the ISO 15118 framework, and thus the OEM (e.g., a vehicle manufacturer) must accommodate a back-end system to be able to swap these certificates within the vehicle. This is undesirable to the OEMs because of the required computing resources for the first subprocess described above. For example, each provisioning certificate requires establishing a trust store containing all relevant Root Certificates from a RootCertificate Pool.

Disclosed implementations improve the process for charging vehicles, and related functions, for vehicle owners/drivers who have multiple contracts with mobility service providers. It solves the problem of legacy vehicles having capacity to store only one certificate and removes the need for contract certificate swapping and management in the vehicle.

A first disclosed implementation is a method for leveraging a single contract certificate stored in a vehicle for accommodating multiple charging contacts in a Plug and Charge ecosystem, the method comprising: a charge station authenticating a vehicle in response to a charging request from the vehicle; in response to the authenticating, validating a contract certificate of the vehicle and authorizing the charging request; mapping the contract certificate of the vehicle to a one of multiple charging contracts linked to the contract certificate of the vehicle; and authorizing the charge station to provide charging services to the vehicle in accordance with the one of multiple charging contracts.

A second disclosed implementation is a system for leveraging a single contract certificate stored in a vehicle for accommodating multiple charging contacts in a Plug and Charge ecosystem, the system comprising: at least one computer processor; and at least one memory device having instructions thereon which, when executed by the at least one computer processor, cause the at least one computer processor to carry out the method of: a charge station authenticating a vehicle in response to a charging request from the vehicle; in response to the authenticating, validating a contract certificate of the ehicle and authorizing the charging request; mapping the contract certificate of the vehicle to a one of multiple charging contracts linked to the contract certificate of the vehicle; and authorizing the charge station to provide charging services to the vehicle in accordance with the one of multiple charging contracts.

### BRIEF DESCRIPTION OF THE DRAWING

For a better understanding of the various embodiments described herein and to show more clearly how they may be carried into effect, reference will now be made, by way of example only to the attached drawing.

FIG. 1 is an architecture diagram of a computing system in accordance with disclosed implementations.

FIG. 2 is a data flow diagram of a method in accordance with disclosed implementations.

FIG. 3 illustrates a data structure that can be used in accordance with the disclosed implementations.

### DETAILED DESCRIPTION

The following description sets forth exemplary implementations. It should be recognized, however, that such description is not intended as a limitation on the scope of the present disclosure. Rather, the description also encompasses combinations and modifications to those exemplary implementations described herein.

Disclosed implementations include systems and methods for managing multiple mobility service contracts in vehicles, such as electric vehicles. The disclosed implementations include a system that involves the installation of a single contract certificate in a vehicle and a mechanism for mapping the certificate to multiple mobility service provider charging contracts in a dynamic manner. This system provides advantages to vehicle owners who maintain multiple contracts with various mobility service providers, particularly in situations where the vehicle can support the installation of just one contract certificate.

More specifically, the disclosed implementations may include a contract certificate associated with a vehicle owner, with multiple charging contracts of that vehicle owner mapped to the contract certificate. Upon authentication of the contract certificate, a charge point operator may be mandated to verify with the issuer of the charging contract before authorizing the charge. The mapping of the contract certificate to a charging contract may occur dynamically at various stages of a charging operation, differing from existing processes where the contract certificate is statically and directly associated with a single charging contract.

Disclosed implementations include a service provider entity that acts as a directory connecting a charge point operator to the mobility service provider, based a charging contract preferred by the owner/driver and/or other charge-specific variables and conditions. This entity may be directed by the EMAID in the contract certificate to a backend system that stores the mappings to each charging contract. This approach simplifies the process for vehicle drivers who have multiple contracts with mobility service providers and eliminates the need for the OEM backend to have a capability for swapping contract certificates. The result is that the charging process is convenient and flexible for the vehicle owner.

The contract certificate may be stored in a secure digital format within the vehicle's onboard computer system. This digital storage may allow for easy access and management of the contract certificate and may eliminate the physical constraints associated with traditional contract certificate storage methods. In other implementations, the contract certificate may be stored on a physical device, such as a smart card, that can be inserted into the vehicle. This physical storage method may provide an additional layer of security, as the contract certificate can be physically removed from the vehicle when not in use. Regardless of the storage method, the contract certificate may serve as a versatile tool for managing multiple mobility service contracts in vehicles, providing flexibility and convenience to the vehicle owner.

Upon installation of the contract certificate in the vehicle, an authentication process may be initiated. This process may involve the verification of the contract certificate's digital signature or other identifying information in a conventional manner. In some cases, the authentication process may involve multi-factor authentication that requires the vehicle owner to provide additional information or credentials. This additional information can include, for example, a password, a personal identification number (PIN), or a biometric identifier such as a fingerprint or facial recognition data.

Once the contract certificate is authenticated, the charge point operator may be mandated to verify the charging contract with the issuer before authorizing the charge. This verification process may involve the charge point operator communicating with the issuer of the charging contract, which may be a mobility service provider or another entity. The charge point operator may send a request to the issuer, including the EMAID from the contract certificate and other relevant information, and the issuer may respond with confirmation of the validity of the charging contract.

The mapping of the contract certificate to one of multiple charging contracts can occur at this stage. This mapping process can involve associating the authenticated contract certificate with one or more charging contracts stored in a backend system. The backend system may store mappings between contract certificates and charging contracts and may be accessed by the charge point operator to determine the appropriate charging contract based on the authenticated contract certificate and the driver's preference (as well as other variables and conditions).

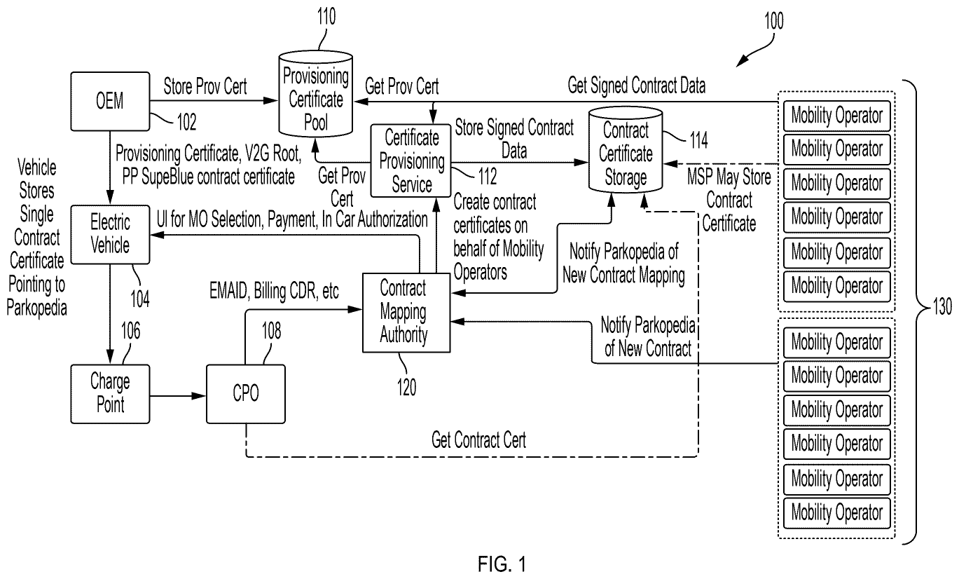

FIG. 1 illustrates a networked computing system in accordance with disclosed implementations. System 100 includes computing systems controlled and operated by the various parties as described below. OEM 102 is responsible for creating a contract certificate, including all authentication and validation, and installing the contract certificate in the vehicle 104. OEM 102 is typically the manufacturer of the vehicle. The contract certificate is stored in the vehicle 104 or on a removable device that can be communicatively coupled to the vehicle.

The OEM also creates a root certificate (that can be used to verify the contract certificate) and a provisioning certificate. The provisioning certificate establishes trust between an EV and the charging infrastructure in a conventional manner. The OEM creates a provisioning certificate for each EV. The provisioning certificate contains essential information about the vehicle, including its identity and security details. The provisioning certificate includes a unique identifier of the vehicle, cryptographic keys, and other relevant data. The provisioning certificate is stored in provisioning certificate pool 110 and managed by certificate provisioning service 112.

Various contracts, containing terms and conditions, and accounting information, can be stored in contract certificate storage 114. The contracts specify the terms and conditions under which a vehicle may obtain charging services from a charge point operator (such as CPO 108). A single vehicle may have several contracts with various mobility operators 130 in accordance with the disclosed implementations. Mobility operators (also known as e-mobility service provider (EMSP) or e-mobility provider (EMP)) are entities that facilitate seamless charging experiences for EV owners. Mobility operators act serve as an intermediary between the EV driver and the charging infrastructure and typically provide the following services:
Billing and Account Management: EV owners sign up with a mobility operator to create a billing account. This account enables them to access charging services.
Authentication and Authorization: The mobility operator verifies the identity of the EV owner and ensures they have the necessary permissions to use charging stations.
Service Provision: The MO provides access to a network of charging stations, allowing EV owners to charge their vehicles conveniently.
Payment Handling: When an EV owner uses a charging station, the mobility operator handles payment transactions.

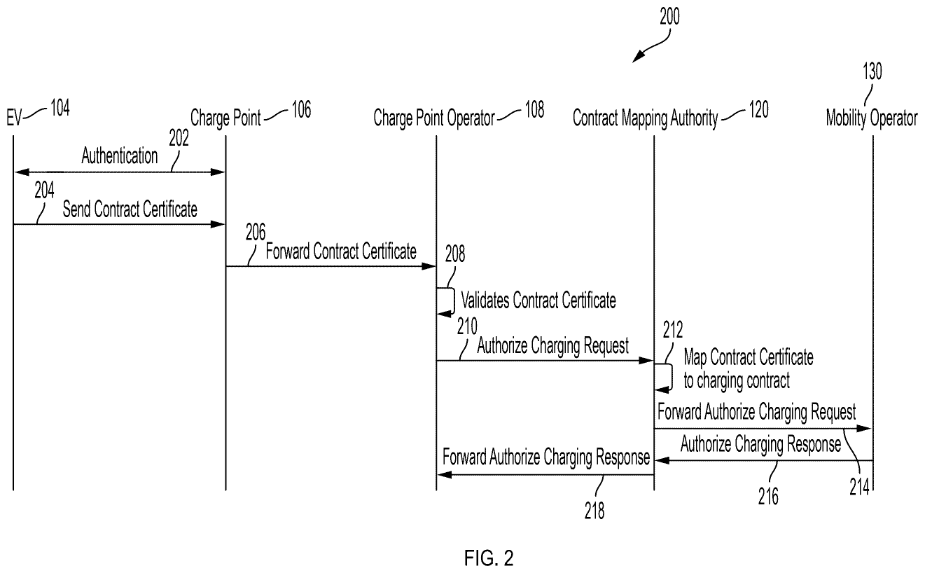

When vehicle 102 requests a charge at a charging station, such as charge point 106, charge point 106 communicates with corresponding charge point operator 108. Charge point operator 108 requests a contract certificate for vehicle 102 from contract mapping authority 120, which maps the contract certificate in vehicle 102 to a desired one of multiple charging contracts between the vehicle owner and mobility operators 130. The contract mapping process is described in great detail below with respect to FIG. 2.

FIG. 2 is a process diagram illustrating contract mapping process 200 in accordance with disclosed implementations. In FIG. 2 elements discussed in FIG. 1 are labelled in a manner corresponding to FIG. 1. At 202, the vehicle is authenticated, in a conventional manner, by a charger of charge point 106 based on the contract certificate stored in the vehicle. The authentication process is typically triggered when a driver, or other person, couples a charger at the charge point to the vehicle by plugging the vehicle into the charge station.

At 204, information from the contract certificate stored in the vehicle is sent to the charge point and the information is transmitted to charge point operator 108 at 206. At 208, charge point operator 108 validates the contract certificate in a conventional manner. At 210, charge point operator 108 authorizes the charging transaction and sends an indication of the authorization to contract mapping authority 120. At 212, contract mapping authority 120 maps the contract certificate to an appropriate contract. The appropriate charging contract could be one of many charging contracts corresponding to the vehicle and is selected based on the identity of charge point operator 108 and/or charge point 106 and/or mobility operator 130. Various other variables and conditions can be used to map the contract as will be apparent to one of skill in the art.

At 214, a charge authorization request is forwarded to the mobility operator 130 who is party to the contract and at 216, mobility operator 130 responds with a charge authorization. At 218, the authorization is forward to charge point operator 108 to allow charging of vehicle 104 to be commenced and competed under the terms of the contract.

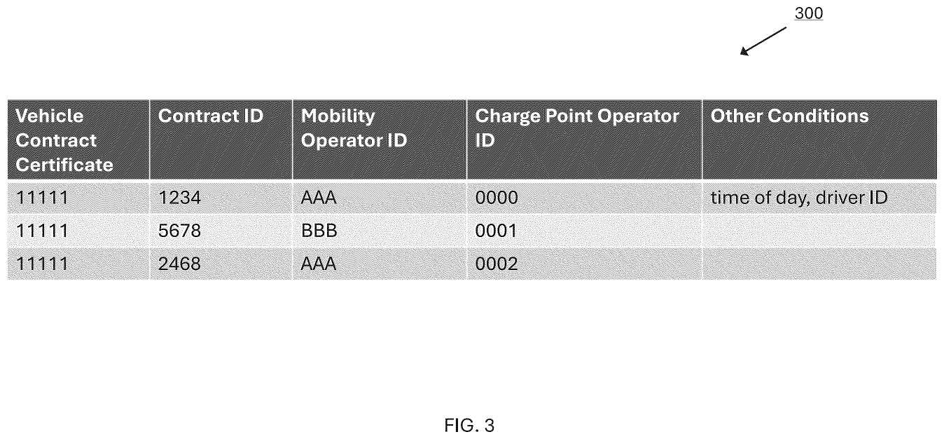

FIG. 3 illustrates a simple example of a data structure that can be stored by contract mapping authority 120 and leveraged for mapping a contract certificate to multiple contracts. Data structure 300 is for a singe vehicle and thus the Vehicle Contract Certificate is the same in all three rows. It can be seen that data structure 300 links the Vehicle Contract Certificate with multiple Contract IDs and associated Mobility Operator IDs and Charge Point Operator IDs. For example, as seen in the third row, the contract c certificate of the vehicle is linked to Contract ID 2468 when the Mobility Operator ID is AAA and the Charge Point Operator ID is 0002.

Also, as shown in the right-most column of data strucutre 300, the mapping to the contract can be dependent on conditions, such as time and driver identity. For example, a clock associated with the system can be queried to see if time conditions are satisfied and the user interface can be used to require the driver to present some sort of identification, such as a password.

Disclosed implementations provide a back-end system that provides a proxy/twin of the vehicle, in the form of the contract mapping authority. Mobility operators and other parties can operate in a conventional manner, without the need to reconfigure standardized processes and need not even have knowledge of the proxy/twin. Management of contracts becomes isolated from service provision to thereby avoid the limitations of conventional plug and charge systems that are discussed above.

In some cases, the backend system may be a centralized system managed by a trusted entity, such as a mobility service provider or a third-party service provider. In other cases, the backend system may be a decentralized system based on blockchain technology or another distributed ledger technology. Regardless of the specific implementation, the backend system may provide a secure and efficient means of storing and accessing the mappings between contract certificates and charging contracts, thereby facilitating the management of multiple mobility service contracts in vehicles. The mapping data can be stored as a relational database or in any other known manner.

A decentralized system may provide increased security and transparency, as all transactions, including the mapping of contract certificates to charging contracts, may be recorded on a public ledger. This decentralized approach may also provide redundancy and resilience, as the data is not stored in a single location but is distributed across multiple nodes in the network.

The mapping of the contract certificate to one or many charging contracts may occur at the verification or authentication stage. This mapping process may involve associating the authenticated contract certificate with one or more charging contracts stored in a backend system at the charge point. The backend system may store mappings between contract certificates and charging contracts and may be accessed by the charge point operator to determine the appropriate charging contract based on the authenticated contract certificate and the driver's preference.

The contract certificate may include an EMAID that serves as a globally-unique identifier that can be used to identify the vehicle owner's account with the mobility service provider. The EMAID in the contract certificate may direct the charge point operator to the backend system that stores the mappings to each charging contract. This direction may occur upon the authentication of the contract certificate, thereby facilitating the verification process with the issuer of the charging contract before authorizing the charge.

In some implementations, the vehicle owner may select their preferred charging contract through a user interface. The user interface may be designed in various ways to provide flexibility and convenience to the vehicle owner. For instance, in some cases, the user interface may be a simple menu on the vehicle's infotainment system. This menu may display a list of available charging contracts, allowing the vehicle owner to easily select their preferred contract. In other cases, the user interface may be a mobile application that allows the vehicle owner to select their preferred charging contract from their smartphone. This mobile application may provide the vehicle owner with the flexibility to manage their charging contracts remotely, thereby enhancing the user experience. Regardless of the specific design of the user interface, it may provide a convenient and efficient means for the vehicle owner to select and manage their multiple mobility service contracts.

The system for managing multiple mobility service contracts in vehicles may be integrated with other technologies to enhance functionality. For instance, the system may be integrated with a Global Positioning System (GPS) to automatically select the charging contract that offers the lowest rates based on the vehicle's current location. This integration may involve the GPS system providing real-time location data to the backend system, which may then use this data to determine the charging contract that offers the lowest rates for the given location.

The system may be integrated with a payment system to automatically deduct the charging costs from the vehicle owner's account. This integration may involve the payment system communicating with the backend system to retrieve the cost of the charging session based on the selected charging contract. Once the cost is retrieved, the payment system may automatically deduct this cost from the vehicle owner's account, thereby eliminating the manual payment process and enhancing the convenience for the vehicle owner. Regardless of the specific integration, the system may provide a more efficient and user-friendly process for managing multiple mobility service contracts in vehicles.

The system for managing multiple mobility service contracts in vehicles may be adapted to manage contracts for different types of energy sources. For instance, it could be adapted to work with hybrid vehicles that use both electricity and gasoline. In such cases, the system may manage contracts with both electric charging providers and gasoline providers. This adaptation may involve the contract certificate mapping to charging contracts for both types of energy sources, thereby providing flexibility and convenience to the vehicle owner.

The system for managing multiple mobility service contracts in vehicles may include additional safety features to protect the vehicle owner's information and prevent unauthorized access. For instance, the system may incorporate encryption techniques to protect the contract certificate and the mappings to each charging contract. This encryption may involve the use of cryptographic algorithms to convert the contract certificate and the mappings into a format that can be read and understood only with the correct decryption keys.

The system may include a feature that automatically locks the system after a number of unsuccessful authentication attempts. This automatic lock feature may be designed to prevent unauthorized access to the system by limiting the number of attempts that can be made to authenticate the contract certificate. For instance, if the system detects a predetermined number of unsuccessful authentication attempts, it may automatically lock the system and prevent further attempts until the vehicle owner or an authorized individual unlocks the system. This approach may provide an additional layer of security, as it may deter unauthorized individuals from attempting to gain access to the system through repeated authentication attempts.

Disclosed implementations may utilize conventional computing devices to facilitate various functions. These computing devices can include, but are not limited to, servers, onboard vehicle computers, smartphones, tablets, and personal computers. The use of these devices may enable vehicle owners to interact with the system through user interfaces such as mobile applications, web portals, or vehicle infotainment systems. For instance, a vehicle owner may use a smartphone application to select their preferred charging contract, which is then communicated to the vehicle's onboard computer system. This onboard system may be responsible for authenticating the contract certificate and initiating the verification process with the charge point operator.

Conventional computing devices may also be employed by charge point operators and mobility service providers to manage their interactions with the system. Charge point operators can use these devices to access the backend system for verifying charging contracts, while mobility service providers may use them to update contract terms, manage accounts, and provide customer support. The backend system itself may be hosted on servers that are accessed by these computing devices over the internet or other networks.

The various protocols and data structures, interfaces, and the like required to practice the disclosed implementations will be apparent to one of skill in the art based on the relevant published standards and the disclosure herein. All functions disclosed herein can be implemented as “modules” of computer readable code stored on non-transitory media and executed by one or more computer hardware processors. The disclosure refers to several entities, such as mobility operators, OEMs, and charge point operators. Reference to these entities herein is intended to encompass any computing devices and/or systems associated with the entity that are used by the entity for communication over a computer network and the processing functions described herein.

A number of implementations have been described. Nevertheless, it will be understood that various modifications may be made without departing from the spirit and scope of the disclosure. Accordingly, other implementations are within the scope of the invention as defined by the following claims.

What is claimed:

1. A method for leveraging a single contract certificate stored in a vehicle for accommodating multiple charging contacts in a Plug and Charge ecosystem, the method comprising:
a charge station authenticating a vehicle in response to a charging request from the vehicle;
in response to the authenticating, validating a contract certificate of the vehicle and authorizing the charging request;
mapping the contract certificate of the vehicle to a one of multiple charging contracts linked to the contract certificate of the vehicle; and
authorizing the charge station to provide charging services to the vehicle in accordance with the one of multiple charging contracts.

2. The method of claim 1, wherein the mapping is performed by a service provider computing system.

3. The method of claim 2, wherein the service provider computing system is a centralized computing system.

4. The method of claim 2, wherein the service provider computing system is a decentralized computing system.

5. The method of claim 1, wherein the authenticating is based on an EMAID associated with the vehicle.

6. The method of claim 1, wherein the contract certificate is stored in a memory device of the vehicle.

7. The method of claim 1, wherein the contract certificate is stored in a removable memory device that can be selectively coupled with the vehicle.

8. The method of claim 1, wherein the mapping is based on at least one of a charge point operator or a mobility operator.

9. A system for leveraging a single contract certificate stored in a vehicle for accommodating multiple charging contacts in a Plug and Charge ecosystem, the system comprising:
at least one computer processor; and
at least one memory device having instructions thereon which, when executed by the at least one computer processor, cause the at least one computer processor to carry out the method of:
a charge station authenticating a vehicle in response to a charging request from the vehicle;
in response to the authenticating, validating a contract certificate of the vehicle and authorizing the charging request;
mapping the contract certificate of the vehicle to a one of multiple charging contracts linked to the contract certificate of the vehicle; and
authorizing the charge station to provide charging services to the vehicle in accordance with the one of multiple charging contracts.

10. The system of claim 9, wherein the mapping is performed by a service provider computing system.

11. The system of claim 10, wherein the service provider computing system is a centralized computing system.

12. The system of claim 10, wherein the service provider computing system is a decentralized computing system.

13. The system of claim 9, wherein the authenticating is based on an EMAID associated with the vehicle.

14. The system of claim 9, wherein the contract certificate is stored in a memory device of the vehicle.

15. The system of claim 9, wherein the contract certificate is stored in a removable memory device that can be selectively coupled with the vehicle.

16. The system of claim 9, wherein the mapping is based on at least one of a charge point operator or a mobility operator.
